(19) United States
(12) Patent Application Publication
(10) Pub. No.: US 2010/0007663 A1
(43) Pub. Date: Jan. 14, 2010

(54) MEDICAL IMAGE DISPLAY CONTROL DEVICE AND METHOD FOR OPERATING MEDICAL IMAGE DISPLAY CONTROL DEVICE

(75) Inventor: Kazuhiko MATSUMOTO, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: ZIOSOFT, INC., Tokyo (JP)

(21) Appl. No.: 12/497,258

(22) Filed: Jul. 2, 2009

(30) Foreign Application Priority Data
Jul. 9, 2008 (JP) 2008-179486

(51) Int. Cl. G06T 17/00; G06F 3/048

(52) U.S. Cl. 345/424; 715/788

(57) ABSTRACT

A medical image display control device visualizing a tubular tissue in volume data to perform operations comprising: path acquisition means for acquiring a path along the tissue; first range specifying means for accepting user specification of a specified range of the path; first display control means for visualizing the tissue, and for indicating the positions of relatively fixed to the window; first setting means for setting cross-sectional planes crossing the path corresponding from the positions; second display control means for visualizing each cross-sections of the tissue by the planes; second range specification means accepting a new specification of a range of the path; third display control means for visualizing the tissue, and for indicating the positions of relatively fixed to the window; second setting means for setting new planes crossing the path corresponding to the positions; and fourth display control means for visualizing each cross-sections of the tissue by the new planes.

### SPECIFICATION

1. Technical Field

The present invention is related to a medical image display control device that displays a specified range of the path that runs along tubular tissue and cross-sectional planes that cross the path on a display means, and more particularly to a medical image display control device that displays the image while sequentially changing the specified range of the path and the cross-sectional planes.

2. Background Art

In recent years, devices such as a Computed Tomography (CT) device and a Magnetic Resonance Imaging (MRI) device have been developed together with the progress of image processing technology using computers. It has become possible to directly observe internal tissue or structures of the human body, and currently medical diagnosis using tomographic images of a living body that were taken by these kinds of devices is widely performed.

Volume rendering, in which a computer directly produces images of three-dimensional structures from volume data, is being used in medical diagnosis. With these images, it becomes possible to observe (visualize) images of complex three-dimensional structures inside a human body that were difficult to comprehend with just tomographic images, and thus the inside of the human body has been easily understood.

One example of an image display method using volume rendering is Multi Planar Reconstruction (MPR) images that are images of arbitrary cross-sectional plane, extracted from volume data of a tubular tissue (blood vessel, large intestine, etc.). In MPR images, for example, images are created from volume data of tubular tissue cut orthogonally across the path of that tubular tissue (images that are so-called sliced images of the tubular tissue). Moreover, there are variations of MPR, so called thick MPR images or slab MIP images. Those are obtained from MPR processing having a certain amount of thickness (slab) in order to reduce noise and to observe curved tissue such as a blood vessel. Moreover, there are Virtual Endoscope (VE) images that creates images by a perspective projection method that sets a viewpoint inside the tubular tissue, which simulate an endoscope; and furthermore, in addition to thick VE images that combine thick MPR images and VE image processing, VE images with MPR that combine MPR image processing with VE image processing, sphere VE images (fish-eye projected images), and thick MIP images are also used.

Another example of an image display method using volume rendering is a Curved Multi Planer Reformation (CPR) image processing method (for example, refer to Non-patent documents 1 and 2). In CPR, a curved plane is cut along the path direction of the tubular tissue (in other words, along the direction of the tubular tissue) is generated from the volume data of the tubular tissue and displayed. The following three kinds of CPR images are used according to the technique used when displaying the curved plane as a two-dimensional image: projected CPR images, expanded CPR images, and straight CPR images. Particularly, Straight Curved Multi Planar Reconstruction (Straight CPR) images are suitable for over viewing the entire tubular tissue.
Non-patent document 1: CPR-Curved Planer Reformation, Armin Kanistar, Dominik Fleischmann, Rainer Wegenkittl, Petr Felkel, Meister Eduard Groller, IEE VISUALIZATION. IEEE Computer Society 2002, 37-44
Non-patent document 2: “Development of an Automated CPR Display System for CT and MR Images”, Takashi Shirahata, Yoshihiro Goto, Research & Development Center, Hitachi Medical Corp. Technical report MEDIX VOL. 43, P. 41-P. 44

Straight CPR images are applied for over viewing the entire tubular tissue. A shortcoming of straight CPR images is its large distortion. Therefore, when observing a blood vessel, in order to perform diagnosis of an aneurysm or a stenosis, it is necessary to precisely evaluate and observe the condition of the tubular tissue under observation such as the stenosis rate or diameter of the blood vessel. Therefore, first, the observation is performed using the planar image obtained from the straight CPR image described above by cutting along the path direction of the tubular tissue, then by further generating cross sectional images (images that slice the tubular tissue perpendicularly across its path) using MPR images of sites in which a stenosis may have been found, or where there may be a polyp, those sites are observed.

When doing this, a physician operating the computer views the cutaway image in the direction of the path of the tubular tissue that is expressed by a straight CPR image, then by using a cursor on this straight CPR image to specify a site for the MPR image (site suspected to be a stenosis), displays a cross-sectional image by MPR (hereafter, the cross section image of the tubular tissue that is cut perpendicularly across the path will be referred to as a MPR image) of a site that corresponds to that specified as straight CPR image. Therefore, in this case, for example, when a physician creates a pan view of a straight CPR image that is displayed on the window in the path direction, he or she then uses the cursor again to specify a site on the straight CPR image where its MPR image is desired, and displays the MPR image of the site that corresponds to the specified straight CPR image.

When observing a tubular tissue in this way, even though straight CPR images and MPR images are supposed to be closely related to each other, conventionally, the correlation between these display planes was not taken into consideration.

Assume an occasion that, the physician is making observations with panning the straight CPR image in the path direction. The physician shall pan the straight CPR image in the path direction, find a suspicious point, specify a site for the MPR image, observe the MPR image, go back to panning the straight CPR image, and then repeat all. This requires the operator (for example, a physician) to perform a large amount of work in order to view several windows and straight CPR images of a tubular tissue.

Therefore, taking into consideration the aforementioned problems, the object of the present invention is to provide a medical image display control device that, when displaying a specified area of a straight CPR along the path of a tubular tissue and cross-sectional planes such as MPR images that cross the path, is capable of smoothly linking the display of the cross-sectional planes such as MPR images to the display such as a straight CPR or the like of a specified area along the path of a tubular tissue without being troublesome to the operator.

### SUMMARY OF THE INVENTION

To solve the problems, one aspect of the invention is a medical image display control device visualizing a tubular tissue in volume data to perform operations comprising: path acquisition means for acquiring a path along the tubular tissue; first range specifying means for accepting user specification of a specified range of the path; first display control means for visualizing the tubular tissue within the specified range on a window, and for indicating two or more positions of relatively fixed to the window; first setting means for setting two or more cross-sectional planes crossing the path corresponding from the two or more positions on the window and the specified range of the path; second display control means for visualizing each cross-sections of the tubular tissue by the two or more cross-sectional planes; second range specification means accepting a new specification of a range of the path; third display control means for visualizing the tubular tissue within the new specified range on the window, and for indicating the two or more positions of relatively fixed to the window; second setting means for setting two or more new cross-sectional planes crossing the path corresponding to the two or more positions on the window and the specified range of the path; and fourth display control means for visualizing each cross-sections of the tubular tissue by the two or more new cross-sectional planes.

According to the present invention, by linking the specified range of the path and the window coordinate, manipulating visualized image does newly specify the range along the path. And, it smoothly links the display of the cross-sectional planes with the display of the newly specified range along the path.

One aspect of the invention is the medical image display control device of claim 1, wherein the second range specification means specifies the new range by panning the visualized tubular tissue on the window.

According to the present invention, the operator or physician uses a pointing device to pan the displayed image. Then range of the path which is currently displayed will be the newly specify the range along the path. For this keeping the line of sight fixed on the cross-sectional planes that are displayed on the window, the cross-sectional planes are automatically updated and displayed as the cutaway plane is updated, so it makes the operator or physician to check each of the cross-sectional planes without moving one's line of sight.

One aspect of the invention is the medical image display control device of claim 1, wherein the first display control means and the third display control means visualize the tubular tissue by cylindrical projected image processing.

According to the present invention, by linking the specified range of the path and the window coordinate, manipulating visualized image does newly specify the range along the path. And it smoothly links the display of the cross-sectional planes with the display of the newly specified range along the path.

Another aspect of the invention is the medical image display control device of claim 1, wherein the first display control means and the third display control means visualize the tubular tissue by straight Curved Multi Planar Reconstruction (CPR) image processing.

According to the present invention, by linking the specified range of the path and the window coordinate, manipulating visualized image does newly specify the range along the path. And it smoothly links the display of the cross-sectional planes with the display of the newly specified range along the path.

One aspect of the invention is the medical image display control device of claim 1, wherein the second display control means and the fourth display control means visualize each cross-sections of the tubular tissue by Multi Planar Reconstruction (MPR) image processing.

According to the present invention, by linking the specified range of the path and the window coordinate, manipulating visualized image does newly specify the range along the path. And it smoothly links the display of the cross-sectional planes with the display of the newly specified range along the path.

One aspect of the invention is the medical image display control device of claim 1, wherein the second display control means and the fourth display control means visualize each cross-sections of the tubular tissue by Virtual Endoscope (VE) images, VE images with MPR, thick VE images, sphere VE images, or thick MIP image processing.

According to the present invention, VE images, VE images with MPR, thick VE images, sphere VE images or thick MIP images that cross the path are used as cross-sectional planes, and it is possible to display images (VE images, VE images with MPR, thick VE images, sphere VE images or thick MIP images) that are linked to a newly specified range along the path.

One aspect of the invention is the medical image display control device of claim 4, wherein the second range specification means additionally specifies rotation angle around the path as an axis; the third display control means visualizes the tubular tissue rotated around the path as an axis by the angle; and the fourth display control means visualizes each cross-sections of the tubular tissue rotated around the path as an axis by the angle.

According to the present invention, the operator or physician uses a pointing device to rotate the object in the displayed image. Then range of the path which is currently displayed will be the newly specify the range along the path. For this keeping the line of sight fixed on the cross-sectional planes that are displayed on the window, the cross-sectional planes are automatically updated and displayed as the cutaway plane is updated, so it makes the operator or physician to check each of the cross-sectional planes in without moving one's line of sight.

One aspect of the present invention is the medical image display control device of claim 1, wherein the second range specification means specifies the new range by giving new zooming ratio.

According to the present invention, the operator or physician uses a pointing device to zoom the displayed image. Then range of the path which is currently displayed will be the newly specify the range along the path. For this keeping the line of sight fixed on the cross-sectional planes that are displayed on the window, the cross-sectional planes are automatically updated and displayed as the cutaway plane is updated, so it makes the operator or physician to check each of the cross-sectional planes in order without having to move the line of sight.

One aspect of the invention is a method for operating a medical image display control device that receiving volume data of a tubular tissue, wherein the volume data is obtained based on a scan of the tubular tissue using one of a tomographic scanner and a magnetic resonance imaging scanner, and wherein the volume data comprises voxels, comprising: path acquisition process of acquiring a path along the tubular tissue; first range specifying process of accepting user specification of a specified range of the path; first display control process of visualizing the tubular tissue within the specified range on a window and for indicating two or more positions of relatively fixed to the window; first setting process of setting two or more cross-sectional planes crossing the path corresponding from the two or more positions on the window and the specified range of the path; second display control process of visualizing each cross-sections of the tubular tissue by the two or more cross-sectional planes; second range specification process of accepting a new specification of a range of the path; third display control process of visualizing the tubular tissue within the new specified range on the window, and for indicating the two or more positions of relatively fixed to the window; second setting process of setting two or more new cross-sectional planes crossing the path corresponding to the two or more positions on the window and the specified range of the path; and fourth display control process of visualizing each cross-sections of the tubular tissue by the two or more new cross-sectional planes.

As described above, according to the present invention, construction is such that a specified range along the path of a tubular tissue and positions on the path where cross-sectional planes that cross the path are to be acquired are set on a display window, so even when the range along the path that is to be displayed is newly specified, it is possible to smoothly link the display of the cross-sectional planes with the display of the newly specified range along the path without being troublesome for the operator.

### BRIEF DESCRIPTION OF THE DRAWINGS

FIG. 1 is a block diagram showing an example of the hardware of an image display device of an embodiment of the present invention.

FIG. 2 is a drawing showing a computed tomography device for obtaining CT image data.

FIG. 3 shows an example of displays of a straight CPR image and MPR images that are displayed on a display unit 14.

FIG. 4 is a drawing explaining MPR acquisition sites a to e that are set on the screen of a display unit 14.

FIG. 5 is a drawing for explaining an update display of a straight CPR image 3 using a panning operation, and an update display of MPR images 4 that are linked to the straight CPR image 3.

FIGS. 6A, 6B and 6C are drawings for explaining an update display of a straight CPR image 3 using a rotation operation, and an update display of MPR images 4 that are linked to the straight CPR image 3.

FIG. 7 is a drawing for explaining an update display of a straight CPR image 3 using a zoom operation, and an update display of MPR images 4 that are linked to the straight CPR image 3.

### BEST MODE FOR CARRYING OUT THE INVENTION

The preferred embodiments of the present invention will be explained below based on the supplied drawings. In the embodiments, an example is explained in which the medical image display control device of the present invention is applied to an image display device that generates and displays a straight CPR image to visualize volume data along a specified range of a blood vessel path (as an example of tubular tissue), and MPR images that cross that path based on volume data that is obtained from CT image data taken by a computed tomography (CT) device.

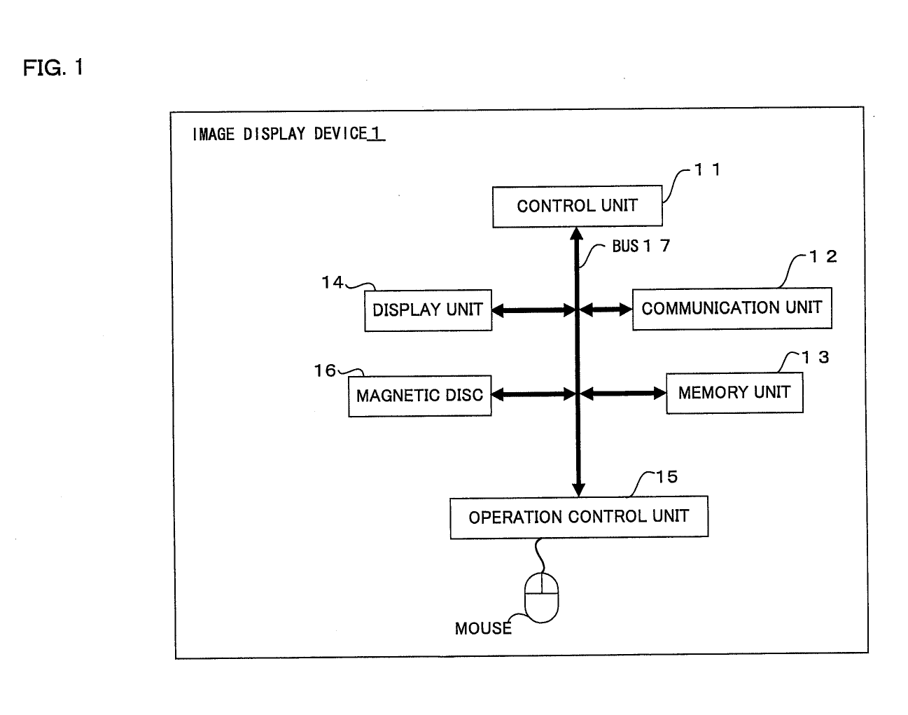

FIG. 1 is a block diagram showing an example of the hardware construction of an image display device of an embodiment of the present invention.

As shown in FIG. 1, the image display device 1 comprises a control unit 11, a communication unit 12, a storage unit 13, a display unit 14, an operation control unit 15 and a magnetic disc 16. Moreover, the control unit 11, communication unit 12, storage unit 13, display unit 14, operation control unit 15 and magnetic disc 16 are all connected together via a bus 17.

The control unit 11 comprises Random Access Memory (RAM) for work area, and Read Only Memory (ROM) that stores various kinds of data and programs (including the medical image display control program of the present invention).

The communication unit 12 is for internally obtaining CT image data that was taken by a computed tomography device (described later) and sent from a database or server device via a network.

The display unit 14 functions as display means for generating and displaying a straight CPR image of a site that is specified by the user operating an operation control unit 15, or for displaying MPR images.

The operation control unit 15 comprises a pointing device, for example, a keyboard, a mouse or wheel-rotation operation control mechanism, or an operation panel such as a keyboard. The operation control unit 15, together with the control unit 11, functions as the specification means of the present invention that receives various operation instructions, site instructions, menu selection instructions from a user and sends instruction signals to the CPU according to those instructions.

The magnetic disc 16 acquires CT image data as needed from a database via the communication unit 12 and a network, and stores that data.

The control unit 11 comprises: a CPU (not shown in the figure); RAM as a work area; ROM that stores various control programs and data, including the medical image display control program of the present invention; and an oscillation circuit; and that based on an operation signal, generates control information for controlling all of the components described above in order to perform an operation that corresponds to operation information that is included in the operation signal, then outputs that control information via the bus 17 to the components in order to control the operation of all of the components.

Furthermore, by executing a medical image display control program that is stored in ROM or the like, the control unit 11, together with the other components, functions as a path acquisition means, first range specifying means, second range specification means, first setting means, second setting means, first display control means, second display control means, third display control means and fourth display control means of the present invention.

In this embodiment of the present invention, the display unit 14 is housed inside the image display device 1, however, an externally connected monitor or the like can be also used as a display means. In this case, construction is such that a display control instruction signal is sent to the display means such as an externally connected monitor via a video card that is mounted inside the image display device 1 and a VGA cable, DVI cable, and BNC cable.

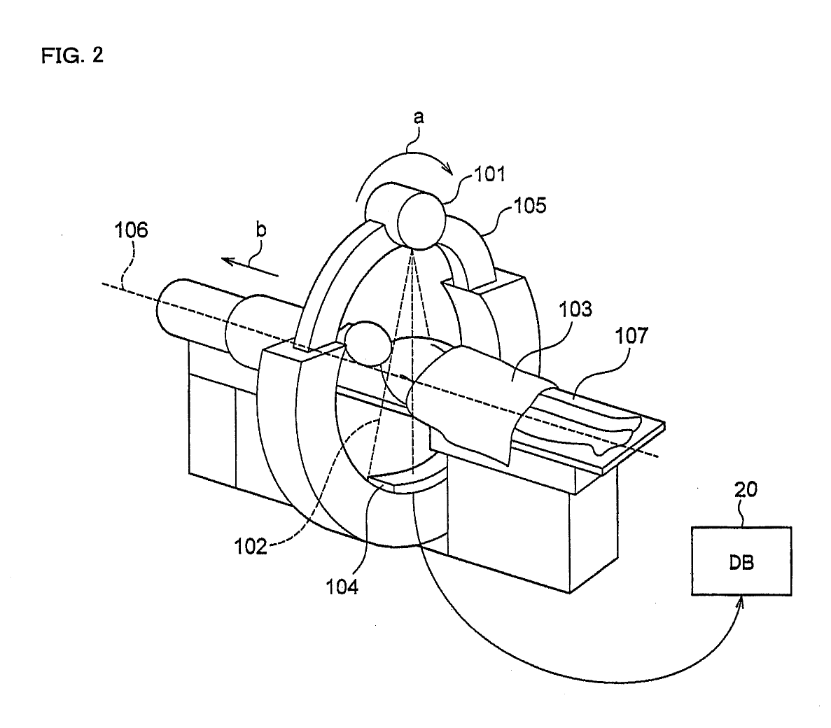

Next, FIG. 2 will be used to explain about the CT image data that the image display device 1 acquires via the communication unit 12.

FIG. 2 shows a computed tomography (CT) imaging device for acquiring CT image data.

A computed tomographic image device 2 uses X rays to acquire data of tissue inside a examined body. A pyramid shaped X-ray beam flux 102 having an edge beam that is indicated by the dashed line in the figure is irradiated from an X-ray source 101. The X-ray beam flux 102 passes through the patient 103 (body being examined), and is irradiated onto an X-ray detector 104. In this embodiment, the X-ray source 101 and X-ray detector 104 are located in a ring-shaped gantry 105 such that they face each other. The ring-shaped gantry 105 is supported by a supporting device (not shown in the figure) such that it is capable of rotating around the system axis line 106 that passes through the center point of the gantry 105 (see arrow a).

There is a table 107 for the patient 103 to lie on, and with the patient 103 on the table 107, the patient 103 is supported by a supporting device (not shown in the figure) so that the patient can move along the system axis line 106 (see arrow b). In addition, this table 107 is constructed such that X rays can pass through it.

The X-ray source 101 and X-ray detector 104 are capable of rotating around the system axis line 106 in this way, and form the measurement system that is capable of moving along the system axis line 106, so the patient 103 can be irradiated with X rays from various angles and positions around to the system axis line 106.

For example, in the case of sequence scanning, scanning is performed for each layer of the patient 103. In this case, the X-ray source 101 and X-ray detector 104 rotate around the patient 103 with the system axis line 106 as the center of rotation, and the measurement system that includes the X-ray source 101 and X-ray detector 104 takes a plurality of images in order to scan two-dimensional tomographical layers of the patient 103. Tomographical images that display the scanned tomographical layers are reconstructed from the measurement values that are acquired when doing this. When performing phase continuous scanning of the tomographical layers, the patient 103 is moved along the system axis line 106. This process is repeated until all of the tomographical layers of interest are obtained.

On the other hand, in the case of spiral scanning, the table 107 is continuously moved in the direction indicated by Arrow b, while the measurement system that includes the X-ray source 101 and the X-ray detector 104 is rotated around the patient 103 with the system axis line 106 as the center of rotation. In other words, the measurement system that includes the X-ray source 101 and X-ray detector 14 continuously moves along a spiral around the patient 103 until all of the areas of interest of the patient 103 have been acquired.

In this way, the images of the patient 103 are taken by a computed tomography imaging device 2, and a plurality of phase-continuous tomographical signals in the diagnosis range of the images are supplied to a database 20.

Moreover, in the database 20 the tomographic signals are accumulated and stored as CT image data, and supplied to the image display device 1 via a network.

Next, the method of the image display control process will be explained in detail with reference to the supplied figures for the case of displaying a straight CPR image and MPR images.

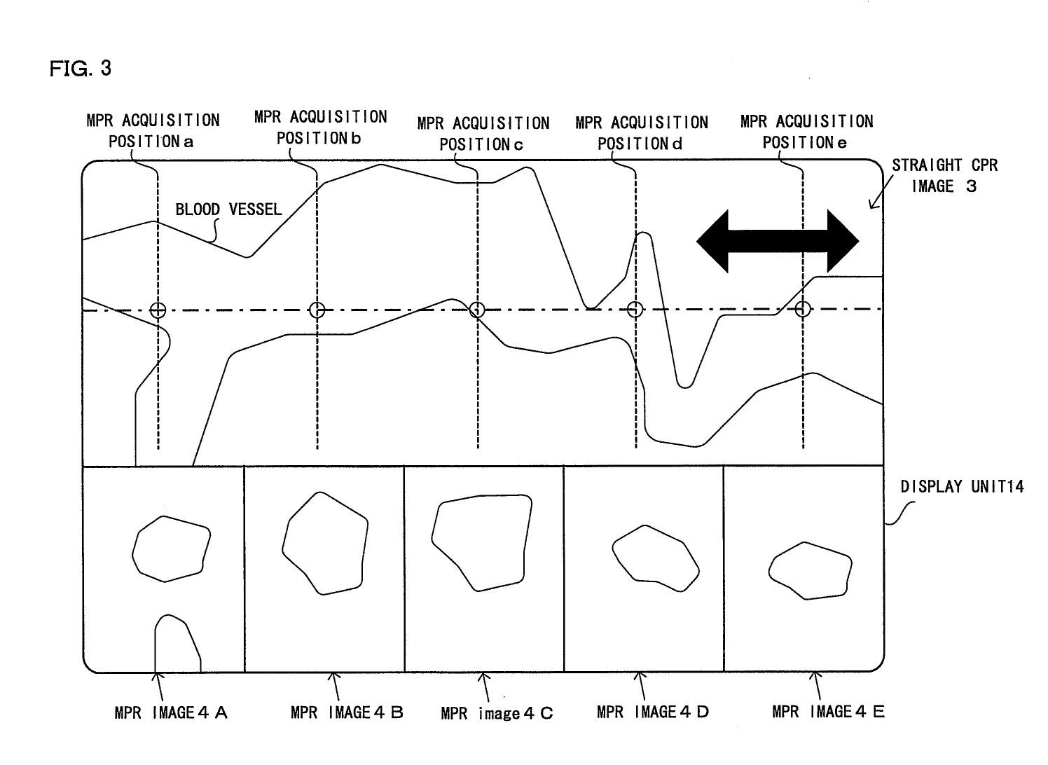

FIG. 3 shows an example of a straight CPR image and MPR images that are displayed on the display unit 14.

First, the control unit 11 has the image processing device 1. CT image data are acquired by a computed tomography device as described above and accumulated in a database 20 from the communication unit 12 via a network.

Then, CT image data are stored on a magnetic disc 16.

In addition, when displaying a straight CPR image and MPR images, the control unit 11 generates volume data from the CT image data that are stored on the magnetic disc 16, and uses that volume data to generate the desired straight CPR image and MPR images. For example, based on the volume data, the control unit 11 generates an arbitrary curved surface that includes the centerline of the observed blood vessel (axis of the blood vessel path; indicated by the dashed line in the figure), and performs straight CPR image processing on that arbitrary curved surface to visualize the volume data within a specified range along the blood vessel path, then generates a straight CPR image 3 that is a cutaway view along that path, and displays that straight CPR image 3 on the display unit 14. As shown in FIG. 3, the line that indicates the centerline of the blood vessel neither necessarily nor strictly have to pass through the center of the blood vessel, and when the blood vessel has a complicated shape due to stenosis, tumor, branching or the like, using the line that closely runs along the blood vessel leads to an image that matches the instinct of the observer. Therefore, the centerline needs to roughly indicate the path of the blood vessel.

Next, from the CT image data that are stored on the magnetic disc 16, the control unit 11 acquires MPR image data (cross-sectional plane information) for each of the positions along the blood vessel path that were specified by the MPR acquisition positions a to e (indicated by the dashed lines in the figure) that were set on the window of image 3 of the display unit 14, then based on the acquired MPR image data, generates MPR images 4A, 4B, 4C, 4D and 4E, and displays the images on the display unit 14. In the example shown in FIG. 3, positions along the path is given from positions a to e that are set at fixed positions on the window of image 3. Then, the MPR images 4 (A, B, C, D, E) are generated from cross-sectional surfaces that cross the blood vessel path at the positions along the path, and the MPR images are displayed on the display unit 14 (at the bottom of the display unit 14 in the figure). In this case, the MPR image 4C, for example, is the observation site, and MPR images 4A, 4B, 4D and 4E are sites compared with that observation site.

Moreover, when a physician operates control 15 unit by mouse, a cursor is displayed on the window of the display unit 14, and that cursor moves in accordance with the motion of the mouse. Then it specifies a new range along the blood vessel path for the straight CPR image 3 to be displayed on the display unit 14. In other words, in order to observe along the path of the blood vessel, the physician pans the currently displayed straight CPR image 3 in the path direction (indicated by the two-directional arrow in FIG. 3) and specifies a new range along the blood vessel path for the straight CPR image 3 to be displayed. By doing this, the physician is capable of generating an image on the window at the same time as operating the mouse, and the physician can seamlessly observe along the path of the blood vessel by sequentially displaying newly specified straight CPR images 3 on the display unit 14.

Here, an example of the procedure for displaying the MPR acquisition positions a to e that are set on the window of the display unit 14 is explained.

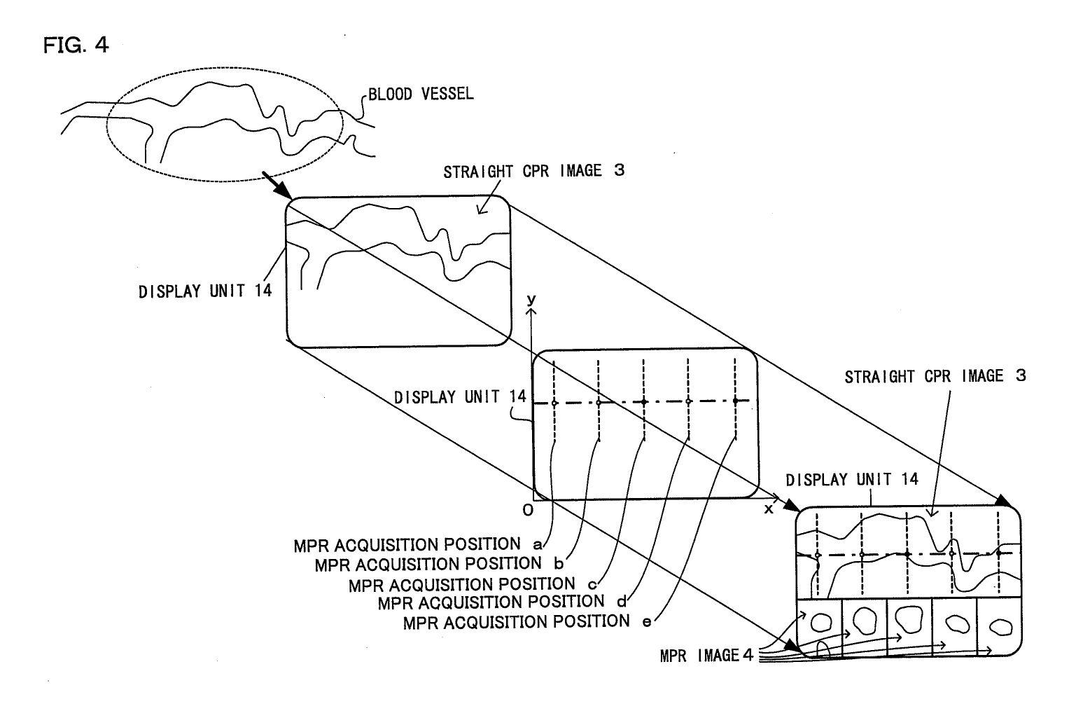

FIG. 4 is a drawing for explaining the MPR acquisition positions that are set on the window of the display unit 14. The path that runs along a blood vessel is already acquired and set.

First, in order to visualize volume data for a specified range along the blood vessel path that is to be displayed on the display unit 14, a straight CPR image 3, which is a cutaway view along the path (area inside the dashed circle in the figure), is generated.

The positions on the blood vessel path are specified according to the MPR acquisition positions a to e that are set on the window of the display unit 14. In other words, the positions for which MPR images 4 (A, B, C, D, E), which are cross-sectional planes that cross the blood vessel path are acquired, are specified by the MPR acquisition positions a to e.

The MPR acquisition positions a to e are set at fixed positions on the window (on the area of which the image is displayed in the display unit 14) of the display unit 14, and using an ‘x’ position coordinate on the window, the position ‘t’ on the blood vessel path that is displayed at that position is acquired. In addition, the coordinate X of the space at position ‘t’ on the blood vessel path is acquired. For example, MPR acquisition position a is set as (xa)→(ta)→X(xa, ya, za), MPR acquisition position b is set as (xb)→(tb)→X(xb, yb, zb), MPR acquisition position c is set as (xc)→(tc)→X(xc, yc, zc), and so on. The direction vector of the blood vessel path at each MPR acquisition position is also acquired.

Moreover, in this way, each position on the blood vessel path are specified according to the positions that are set on the window, the planes of the MPR images are specified by planes in which the direction vectors, which include each of the positions, are taken to be normal vectors, the corresponding MPR image data are acquired, and each of the MPR images 4 (A, B, C, D, E) is generated based on the respective MPR image data and displayed.

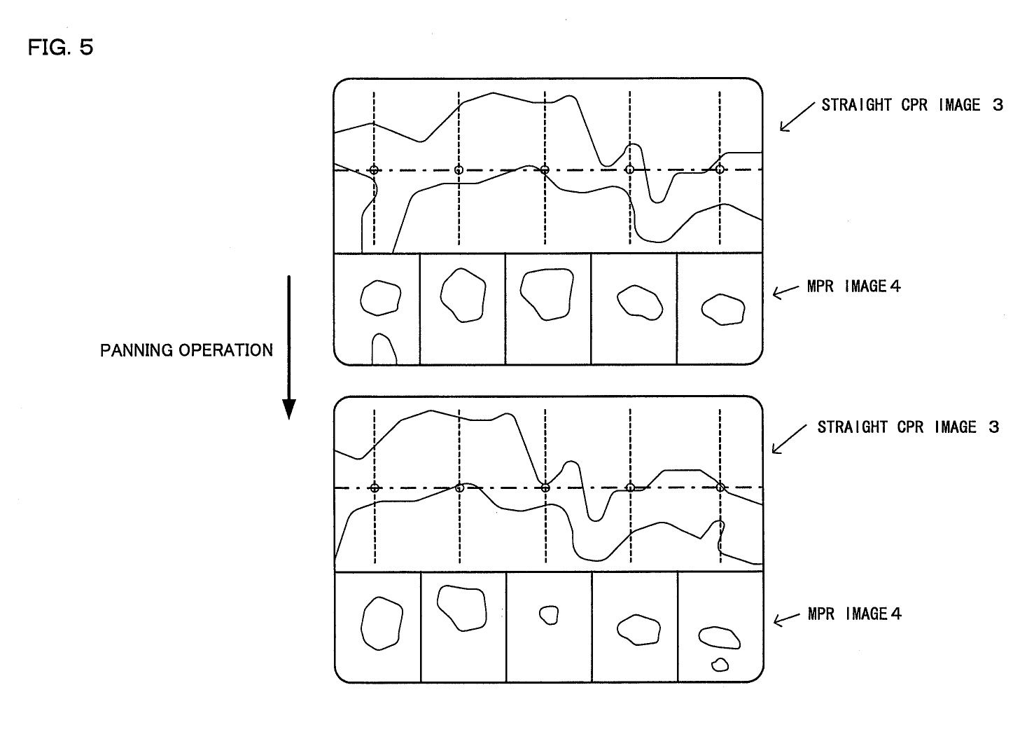

FIG. 5 explains about the display of a straight CPR image 3 by panning and the MPR images 4 (A, B, C, D, E) that are linked to the CPR.

When an examining physician uses the mouse to pan the currently displayed straight CPR image 3 (top in FIG. 5 ), and when a straight CPR image 3 to be newly displayed has been specified, that a new range along the blood vessel path has been specified, that specified straight CPR image 3 (bottom in FIG. 5) is displayed and MPR images 4 (A, B, C, D, E) for positions that correspond to the MPR acquisition positions a to e that are set on the window are automatically generated and displayed. As shown in FIG. 5, by moving the image to the right, a new range along the blood vessel path has been specified.

By setting MPR acquisition positions a to e on the window of the display unit 14 in this way, the MPR images 4 (A, B, C, D, E) that correspond to the MPR acquisition positions a to e that are set on the window of the display unit 14 are automatically generated and displayed when the straight CPR image 3 is updated without the operating physician having to re-specify the positions at which the MPR images are to be generated. In case, the physician is observing the blood vessel along the blood vessel path, MPR images 4 shall be automatically updated after triggered by operation of straight CPR image 3.

In addition, the physician does not need to re-specify the positions at which MPR images 4 are to be generated any longer. Thus, for example, when the physician or physician operates the mouse to pan (update) the straight CPR image 3 with the line of the sight fixed on an observation site (for example MPR image 4C) or a target site (for example, MPR image 4A, 4B, 4D or 4E) of the MPR images 4 that are displayed on the display unit 14, the positions on the path that are specified by the MPR acquisition positions a to e that are set on the window are updated, and together with this, each of the MPR images 4 (A, B, C, D, E) are also automatically updated and displayed. Therefore, the physician or physician is able to sequentially check the MPR images 4 without moving the line of sight, which makes observation easier to perform.

In the embodiment described above, a method of displaying (specifying) a new straight CPR image 3 by panning was explained, however the invention is not limited to this, and construction is also possible in which a straight CPR image 3 is specified as a range on the path that is to be newly displayed by rotating the straight CPR image 3, and by doing so, MPR images 4 (A, B, C, D, E) that correspond to the MPR acquisition positions a to e are automatically generated and displayed.

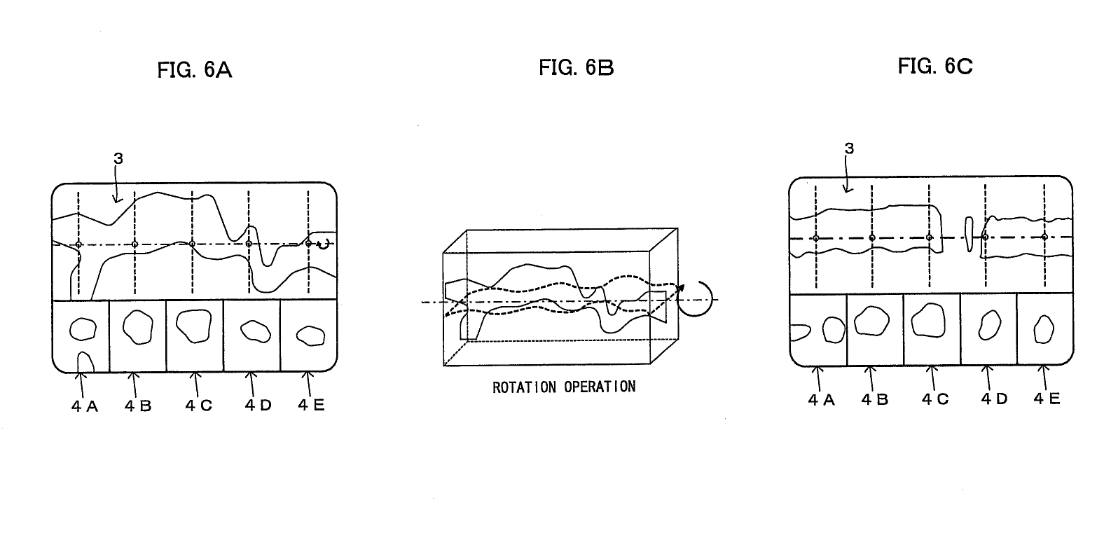

FIGS. 6A, 6B and 6C are drawings for explaining the display of a straight CPR image 3 that is displayed by rotation, and the display of MPR images 4 (A, B, C. D, E) that are linked to the straight CPR image 3.

Here, construction is such that the cutaway section along the curve of the straight CPR image 3 that is shown in FIG. 6A is rotated. The physician or physician updates the straight CPR image 3 to be displayed (see FIG. 6B) by using a mouse or the like to rotate the axis of rotation (indicated by the dash-dot line) of the blood vessel a specified angle around the center axis thereof.

Moreover, as shown in FIG. 6C, the rotated straight CPR image 3 is displayed on the display unit 14, and together with this, MPR images 4 (A, B, C, D, E) of positions that correspond to the MPR acquisition positions a to e that are set on the window are automatically generated and displayed.

In the case of the rotation operation, all the MPR images 4 (A, B, C, D, E) along the axis of rotation are images that have been rotated in the same direction of rotation and displayed. Therefore, the invention is not limited to acquiring MPR image data (cross-section information) that corresponds to positions on the blood vessel path that are specified by the MPR acquisition positions a to e of the rotated straight CPR image 3 from volume data, and generating and displaying new MPR images 4 (A, B, C, D, E) after rotation based on this data, but construction is also possible in which by using the data after rotating the MPR images 4 (A, B, C, D, E) shown in FIG. 6A by just the amount of rotation (for example, 90 degrees) performed during the rotation operation as cross-section information, the MPR images 4 (A, B, C, D, E) before rotation are all rotated by the same rotation amount (for example 90 degrees) in the same direction, and displayed as the MPR images 4 (A, B, C, D, E) after rotation.

Furthermore, construction is also possible in which the straight CPR image 3 is zoomed in or zoomed out to specify a cutaway section to be newly displayed, and then together with this, automatically generating and displaying MPR images 4 (A, B, C, D, E) that correspond to the MPR acquisition positions a to e.

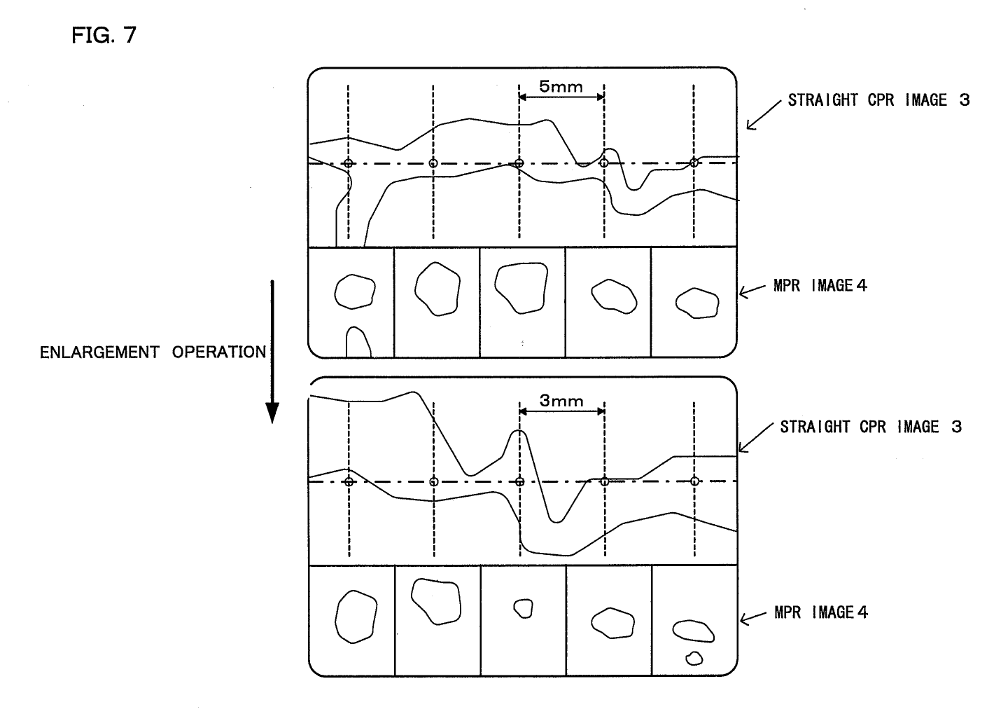

FIG. 7 explains the display of a straight CPR image 3 that is zoomed in, and the display of MPR images 4 (A, B, C, D, E) that are linked to it.

Here, construction is such that by operating a mouse wheel for the straight CPR image 3 shown in FIG. 7, the straight CPR image is zoomed and displayed. The zoomed straight CPR image 3 is displayed on the display unit 14 as shown at the bottom of FIG. 7 and together with this, MPR images 4 (A, B, C, D, E) of positions that correspond with the MPR acquisition positions a to e that are set on the window are automatically generated and displayed.

As shown in the same figure, by enlarging or reducing the straight CPR image 3, spacing between the displayed MPR images 4 is automatically changed. Here, the positions along the path that defines cross-sectional surfaces relatively changes against positions a to e that are set at fixed positions on the window of image 3. In the case of the example shown in the figure, by enlarging the display of the straight CPR image 3, MPR images 4 that are displayed by a spacing of 5 mm can be newly acquired and displayed by a spacing of 3 mm.

When a straight CPR image 3 is specified to be zoomed in or zoomed out in this way, spacing between MPR images 4 will be automatically set. By doing this, it is no longer necessary to directly change the spacing to a suitable value in order to compare MPR images that include the observation sites with MPR images that include comparison sites, and thus it smoothly acquires a plurality of optimum MPR images when performing a zoom operation on a straight CPR image.

Moreover, in the embodiment described above, specifying a new straight CPR image by panning, rotating, or zooming operation is described. However, the invention is not limited to this, and it is also possible to apply the present invention to the case in which a blood vessel that is different from the blood vessel currently being displayed is acquired and volume data along a specified range of that blood vessel path is made to be visualized.

As explained above, with the embodiments of the present invention a straight CPR image 3 that runs along a blood vessel path, and MPR acquisition positions a to e, which are the positions along the path that MPR images 4 cross, are set on the display window, so even when the straight CPR image 3 is newly specified, it is possible to display the MPR images 4 that are linked to that newly specified straight CPR image 3 without being troublesome to the physician. Particularly, when an physician, who is a physician, operates a mouse to perform various operations (for example, panning, rotating and zooming) on the straight CPR image 3 while the line of sight is fixed on an MPR image 4 that is displayed on the window, the MPR images 4 (A, B, C, D, E) are automatically updated when the straight CPR image 3 is updated, so it is possible for the physician or physician to check the MPR images 4 in order without moving the line of sight, so observation becomes easier to perform.

Moreover, with the embodiments of the present invention, a plurality of MPR acquisition positions a to e are set on the window, so it is possible to simultaneously and easily display an observation site and a target site that will be the object of comparison with the observation site.

Furthermore, with the embodiments of the present invention, a plurality of MPR acquisition positions a to e are set on the window, so it is possible to easily know at a glance which sites along the entire blood vessel the MPR images 4 are for.

In the embodiments of this invention described above, an example was explained of a straight CPR image as an image that shows a specified range of a path along a tubular tissue, however, the invention is not limited to this, and it is also possible to use a cylindrical projection image, which is an image of an expanded surface observed from inside a tubular tissue. More specifically, any method can be performed that makes it possible to visualize volume data along a specified range along a path. A Virtual Endoscope (VE) image uses one point on a path as a starting point and makes it possible to visualize volume data, so it is not included as an image that shows a specified range along a tubular tissue.

Moreover, with the embodiments of the present invention, MPR image is explained as an example of cross-sectional planes of a straight CPR image. However the invention is not limited to this, and it is also possible to use VE images, VE images with MPR, thick VE images, sphere VE images, or thick MPR images. The invention can also be embodied using combinations of these, such as “cylindrical projected images” and “sphere VE images”, which are cross-sectional planes thereof. More specifically, any method that makes it possible to visualize volume data with at least one point on a path as a starting point can be used. Particularly, methods that visualize volume data in a plane that includes one point on the path are preferred. For example, VE images with MPR are a combination of MPR images that visualize volume data in a plane that includes a point on a path, and VE images that visualize volume data with one point on the path as a starting point. In addition, particularly in the case of an MPR image, even though the plane of the MPR image is specified by the plane whose normal vector is taken to be the direction vector of the path, the normal vector to the plane of the MPR image can be in any direction. For example, the normal vector of the plane of one MPR image can be the direction vector of the path, and the plane of another MPR images can be parallel to the plane of that MPR image.

In the embodiments of the present invention described above, CT image data is used as an example of image data. However the invention is not limited to this, and the image data used can be the data obtained from a medical image processing device, such as for Magnetic Resonance Imaging (MRI), or data that are a combination of these.

With the embodiments of the present invention, an example of a blood vessel was given as the object to visualize. However any tubular tissue is possible. For example, small intestine, large intestine, cystic duct, trachea, and the like are also possible.

Furthermore, by recording an image display control program on an information recording medium such as a flexible disk or a hard disk, or by acquiring the program via the Internet or the like, and recording it, and then reading and executing the program by an general-purpose computer, it becomes possible to make that computer function as the control unit 11 of the embodiments described above.

As was explained above, the present invention can be used in the field of controlling the display of medical images for displaying a specified range along the path of a tubular tissue and cross-sectional planes that cross that path, and particularly the present inventions are extremely effective when applied to the field of controlling the display of medical images when gradually changing and displaying a specified range along the path of a tubular tissue together with cross-sectional planes thereof.

The present invention may be embodied in other specific forms without departing from the spirit or essential characteristics thereof. The present embodiments and examples are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2006-81575, filed on Mar. 23, 2006, including the specification, claims, drawings and summary are incorporated herein by reference in its entirety.

What is claimed is:

1. A medical image display control device visualizing a tubular tissue in volume data to perform operations comprising:
path acquisition means for acquiring a path along said tubular tissue;
first range specifying means for accepting user specification of a specified range of said path;
first display control means for visualizing said tubular tissue within said specified range on a window, and for indicating two or more positions of relatively fixed to said window;
first setting means for setting two or more cross-sectional planes crossing said path corresponding from said two or more positions on said window and said specified range of said path;
second display control means for visualizing each cross-sections of said tubular tissue by said two or more cross-sectional planes;
second range specification means accepting a new specification of a range of said path;
third display control means for visualizing the tubular tissue within the new specified range on said window, and for indicating said two or more positions of relatively fixed to said window;
second setting means for setting two or more new cross-sectional planes crossing said path corresponding to said two or more positions on said window and said specified range of said path; and
fourth display control means for visualizing each cross-sections of said tubular tissue by said two or more new cross-sectional planes.

2. The medical image display control device of claim 1, wherein
said second range specification means specifies said new range by panning said visualized tubular tissue on said window.

3. The medical image display control device of claim 1, wherein
said first display control means and said third display control means visualize the tubular tissue by cylindrical projected image processing.

4. The medical image display control device of claim 1, wherein
said first display control means and said third display control means visualize the tubular tissue by straight Curved Multi Planar Reconstruction (CPR) image processing.

5. The medical image display control device of claim 1, wherein
said second display control means and said fourth display control means visualize each cross-sections of said tubular tissue by Multi Planar Reconstruction (MPR) image processing.

6. The medical image display control device of claim 1, wherein
said second display control means and said fourth display control means visualize each cross-sections of said tubular tissue by Virtual Endoscope (VE) images, VE images with MPR, thick VE images, sphere VE images, or thick MIP image processing.

7. The medical image display control device of claim 4, wherein
said second range specification means additionally specifies rotation angle around said path as an axis,
said third display control means visualizes the tubular tissue rotated around said path as an axis by said angle; and
said fourth display control means visualizes each cross-sections of said tubular tissue rotated around said path as an axis by said angle.

8. The medical image display control device of claim 1, wherein
said second range specification means specifies said new range by giving new zooming ratio.

9. A method for operating a medical image display control device that receiving volume data of a tubular tissue, wherein the volume data is obtained based on a scan of the tubular tissue using one of a tomographic scanner and a magnetic resonance imaging scanner, and wherein the volume data comprises voxels, comprising:
path acquisition process of acquiring a path along said tubular tissue;
first range specifying process of accepting user specification of a specified range of said path;
first display control process of visualizing said tubular tissue within said specified range on a window and for indicating two or more positions of relatively fixed to said window;
first setting process of setting two or more cross-sectional planes crossing said path corresponding from said two or more positions on said window and said specified range of said path;
second display control process of visualizing each cross-sections of said tubular tissue by said two or more cross-sectional planes;
second range specification process of accepting a new specification of a range of said path;
third display control process of visualizing the tubular tissue within the new specified range on said window, and for indicating said two or more positions of relatively fixed to said window;
second setting process of setting two or more new cross-sectional planes crossing said path corresponding to said two or more positions on said window and said specified range of said path; and
fourth display control process of visualizing each cross-sections of said tubular tissue by said two or more new cross-sectional planes.

10. The method for operating a medical image display control device of claim 9, wherein
second range specification process specifies said new range by panning said visualized tubular tissue on said window.

11. The method for operating a medical image display control device of claim 9, wherein
said first display control process and said third display control process visualize the tubular tissue by cylindrical projected image processing.

12. The method for operating a medical image display control device of claim 9, wherein
said first display control process and said third display control process visualize the tubular tissue by straight Curved Multi Planar Reconstruction (CPR) image processing.

13. The method for operating medical image display control device of claim 9, wherein
said second display control process and said fourth display control process visualize each cross-sections of said tubular tissue by Multi Planar Reconstruction (MPR) image processing.

14. The method for operating a medical image display control device of claim 9, wherein
said second display control process and said fourth display control process visualize each cross-sections of said tubular tissue by Virtual Endoscope (VE) images, VE images with MPR, thick VE images, sphere VE images, or thick MIP image processing.

15. The method for operating a medical image display control device of claim 12, wherein
said second range specification process additionally specifies rotation angle around said path as an axis;
said third display control process visualizes the tubular tissue rotated around said path as an axis by said angle; and
said fourth display control process visualizes each cross-sections of said tubular tissue rotated around said path as an axis by said angle.

16. The method for operating a medical image display control device of claim 9, wherein
said second range specification process specifies said new range by giving new zooming ratio.
